(19) United States
(12) Patent Application Publication
(10) Pub. No.: US 2008/0292312 A1
(43) Pub. Date: Nov. 27, 2008

(54) Method and apparatus for determining optical path attenuation between passive optical network nodes

(75) Inventors: Moshe Oron, San Rafael, CA (US); Muneer Zuhdi, Plano, TX (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Petaluma, Inc., Naperville, IL (US)

(21) Appl. No.: 11/805,049

(22) Filed: May 21, 2007

(51) Int. Cl. H04B 10/08

(52) U.S. Cl. 398/33

(57) ABSTRACT

A method and apparatus of determining attenuation of an optical path between two optical networks may include using a communications traffic signal without interrupting service or requiring additional external test equipment. A transmit optical network node is configured to measure the transmit power of a transmitted optical signal. A receive optical network node is configured to measure the transmit power of the same transmitted optical signal. A calculation unit calculates the power differential of a transmit and receive optical power. A determination unit is configured to determine optical path attenuation as a function of the optical path distance between the transmit and receive optical network nodes. A reporting unit reports data indicative of the optical path attenuation. The optical path attenuation may be monitored periodically, on demand, on an event basis and may report an alert if the attenuation measurement exceeds a preconfigured threshold. The data may be used to proactively monitor quality of an in-service passive optical network by determining the optical path attenuation.

### BACKGROUND OF THE INVENTION

A passive optical network (PON) uses optical fiber to communicate data, video, or audio (herein collectively “data”) between network nodes. As demand for communication services has increased, system operators have increasingly deployed point-to-multipoint PONs. Components such as optical splitter/combiners (OSC) passively split an optical signal into identical copies, allowing a single fiber connection to be shared among multiple users. However, a limited number of OSCs may be used because optical signal power drops each time the signal is split. Thus, a typical PON may use one OSC or perhaps cascade two OSCs. Point-to-multipoint PONs allow a service provider to serve more customers with less equipment thereby decreasing equipment cost on a per user basis.

In a PON, data embedded in a light signal generated by, for example, a laser diode, flows downstream from a transmitting network node, such as an optical line terminal (OLT) to a receiving optical network node, such as an optical network unit (ONU) or optical network terminal (ONT). The same downstream signal flows to all the ONUs but each ONU only retrieves data intended for that particular ONU based on, for example, an identification field unique to that ONU.

Each ONU may, in turn, transmit different upstream signals that are passively combined at the OSC and thereafter received by the OLT. To prevent the individual ONU signals from interfering or colliding with each other, the signals are carefully combined using, for example, a time division multiple access (TDMA) multiplexing technique, where each ONU is assigned a unique time slot in the combined upstream optical signal. A ranging process is used to determine the ‘logical’ distance in order to determine when each ONU should begin transmission of its data in an upstream direction.

The complexity of a multipoint PON architecture, together with system operators avoiding interrupting customer service, has increased difficulty of diagnosing and troubleshooting network problems, resulting in increased maintenance and operation costs.

### SUMMARY OF THE INVENTION

An example method and corresponding apparatus of determining attenuation of an optical path between two optical network nodes may include calculating a power differential between a transmitted optical power of an optical signal and a received optical power of the same optical signal. The transmitted optical power may be measured at a transmitting optical network node. The received optical power may be measured at a receiving optical network node in communication with the transmitting network node via an optical path. The example method may further include determining the optical path attenuation based on the calculated power differential as a function of an optical path distance between the transmitting and receiving optical network node and reporting information indicative of the optical path attenuation.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a network diagram of an example passive optical network (PON);

FIG. 2 is a network diagram of an example portion of a network in which optical elements are configured to determine optical path attenuation in accordance with one embodiment of the present invention;

FIG. 3 is a network diagram of an example portion of a PON in which an Optical Line Terminal (OLT) is configured to determine attenuation of an optical path between the OLT and an Optical Network Unit (ONU) using measurements on a downstream optical signal;

FIG. 4 is a network diagram of an example portion of a PON in which an OLT is configured to determine attenuation of a optical path between the OLT and an ONU using an upstream optical signal;

FIG. 5 is a network diagram of an example portion of a network in which an ONU is configured to determine attenuation of a optical path between the ONU and an OLT;

FIG. 6 is a network diagram of an example portion of a PON illustrating in further detail an optical path distance determination unit;

FIG. 7 is a flow diagram performed in accordance with an example embodiment of the invention;

FIG. 8 is a flow diagram performed in accordance with an example embodiment of the invention; and

FIG. 9 is a flow diagram performed in accordance with an example embodiment of the invention.

### DETAILED DESCRIPTION OF THE INVENTION

A description of example embodiments of the invention follows.

Early implementation of optical networks were deployed as point-to-point networks. With single end nodes, it was relatively easy to determine operating characteristics of the optical link such as optical signal attenuation. Troubleshooting point-to-point optical networks is also a relatively straightforward process as there are only two network nodes. As service demands have increased, network providers have begun deploying point-to-multipoint passive optical network (PON) architectures.

The PON architecture allows a service provider to serve multiple users with less equipment and fiber as compared with equivalent point-to-point architectures. Examples include asynchronous transfer mode (ATM) PONs (APON), broadband PONs (BPON), and more recently Ethernet PONs (EPON) as described in Institute of Electrical and Electronics Engineers 802.3ah and gigabit PONs (GPON) as described in International Telecommunications Union-Telecommunication (ITU-T) G.984. However, because there are many more network nodes, a multipoint PON is more difficult to maintain and more difficult to troubleshoot when service problems occur.

During the installation of a PON, skilled technicians with specialized test equipment may verify that the optical distribution network (ODN) is properly deployed and meets intended performance characteristics. This process is conducted before the service is provided to customers, i.e., during an out-of-service period. After installation, test equipment may be removed, network nodes installed, and service brought on-line.

If service at one of the network nodes, such as an optical network unit, begins to malfunction, customers associated with an associated branch or path of the PON may experience intermittent or complete service interruptions. A skilled technician, equipped with specialized test equipment may be dispatched to troubleshoot, repair, and restart the service—typically an expensive and time consuming process. Optical path measurements may be performed to help isolate and locate a variety of service problems. In addition, optical path measurements may also be performed to ensure the optical path is operating properly and ready to be put back into service.

A number of service problems result from optical path degradation that occurs over time. An ability to conduct in-service optical measurements may provide valuable information to allow a service provider to proactively monitor optical path condition and detect performance degradation before customers begin to experience a loss of service. However, once service is enabled, it becomes much more difficult to perform routine attenuation measurements using existing methods for a number of reasons. Current methods of measuring optical path attenuation may include the halting network service, installing specialized test equipment, such as optical power meters and optical time domain reflectometers, to measure and characterize parameters resulting in system downtime.

Alternative methods may include leaving a number connections attached to the PON and connecting test equipment in the field to perform attenuation measurements, which may include using non-traffic bearing wavelengths to communicate specific, non-traffic bearing test signals. However, the additional test equipment and labor costs can increase operational expenses. Furthermore, the additional test equipment necessarily includes additional connectors, which may adversely impact the PON's power budget, potentially decreasing the number of network nodes, and ultimately customers, a system operator is able to serve. These methods may not provide information indicative of optical path quality to, for example, each ONT.

According to some embodiments of the present invention, a PON is able to determine optical path attenuation while in-service, without additional test equipment or connectors. The technique takes advantage of the fact that current OLT and ONUs now have the ability to measure the transmit and/or receive optical power of an optical signal. Together with optical path distance, such as that determinable using existing ranging data, optical path attenuation may be determined to provide an indication of the optical path quality to each ONT.

In an example embodiment of the invention, a method, or corresponding apparatus, of determining attenuation of an optical path between two optical network nodes includes calculating a power differential between a transmitted optical power of an optical signal and a received optical power of the same optical signal. The transmitted optical power may be measured at a transmitting optical network node and the received optical power may be measured at a receiving optical network node in communication with the transmitting network node via an optical path. The embodiment may include determining optical path attenuation based on the calculated power differential as a function of an optical path distance between the transmitting and receiving optical network nodes and reporting information indicative of the optical path attenuation. The optical signal may be a traffic signal carrying network communications or may be a separate test signal.

An alternative embodiment may include adjusting the calculated power differential to account for fixed power losses between the transmitting and receiving optical network node, and accepting parameters from a user related to the fixed power losses. The method may further include calculating the optical path distance between the transmitting and receiving optical network nodes based on ranging data and may include removing propagation delays of the transmitting and receiving optical network nodes from the optical path distance. Further still, the method may include, alternatively, or in addition, accepting parameters from a user related to the optical path distance (e.g., previously known optical path distance, equipment propagation delays, etc.).

The method may also include forwarding measurements and/or calculated results from the transmitting optical network node to at least one of the following: a management node, a server, a user, or a receiving optical network node. Alternatively, or in addition, the embodiment may include forwarding measurements and/or calculated results from the receiving optical network node to at least one of the following: a management node, a server, a user, or a receiving optical network node. The results may be stored at a node having access to the results or at a repository external from a node having access to the results.

Further still, the method may include monitoring or determining attenuation of the optical path over time, periodically, on an on-demand basis, on an event driven basis, and may alert a service provider if a change in attenuation exceeds a threshold. Reporting may include at least one of the following: issuing an alarm, causing the transmitting or receiving optical network node to change states, issuing a command, issuing a notification, issuing a threshold crossing alert, or reporting a measured result. The transmitting optical network node may be an OLT, and the receiving optical network node may be an ONU downstream of the OLT, or, alternatively, the transmitting optical network node may be an ONU, and the receiving optical network node may be an OLT upstream of the OLT.

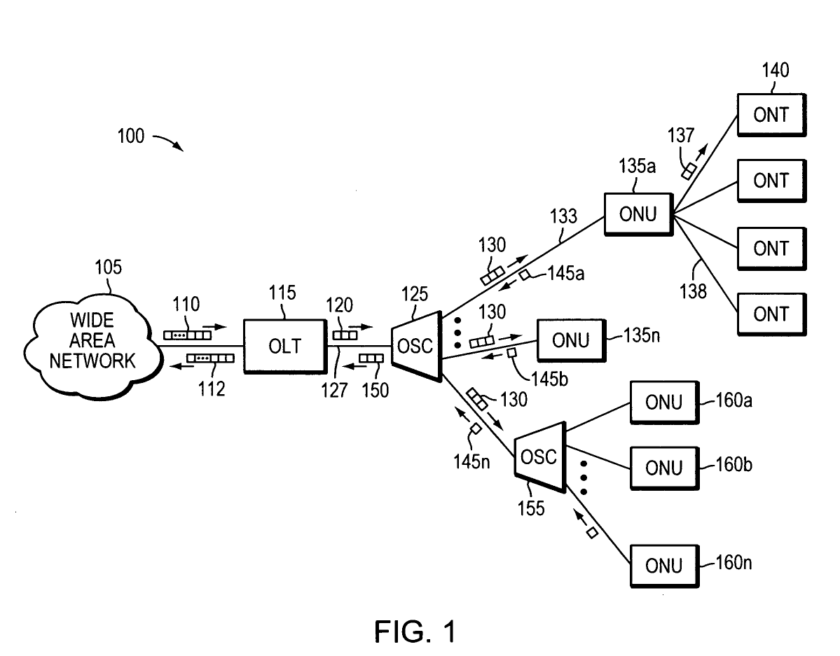

FIG. 1 is a network diagram of a passive optical network (PON) 100 illustrating aspects of an example embodiment of the invention. The PON 100 includes an optical line terminal (OLT) 115, an optical splitter/combiner (OSC) 125, and at least one optical network unit (ONU) 135a-n. The ONUs 135a-n may be in optical communication with multiple optical network terminals (ONTs) 140 directly in electrical communication with end user equipment, such as routers, telephones, home security systems, and so forth (not shown). In other network embodiments, the OLT 115 may be in direct optical communication with the ONTs 140. Data communications 110 may be transmitted to the OLT 115 from a wide area network (WAN) 105. “Data” as used herein refers to voice, video, analog, or digital data.

Communication of downstream data 120 and upstream data 150 transmitted between the OLT 115 and the ONUs 135a-n may be performed using standard communications protocols known in the art. For example, the downstream data 120 may be broadcast with identification (ID) data to identify intended recipients (e.g., the ONUs 135a-n) for transmitting the downstream data 120 from the OLT 115 to the ONUs 135a-n, and time division multiple access (TDMA) for transmitting the upstream data 150 from an individual ONU 135a-n back to the OLT 115. Note that the downstream data 120 is power divided by the OSC 125 into downstream data 130 matching the downstream data 120 “above” the OSC 125 but with power reduced proportionally to the number of paths onto which the OSC 125 divides the downstream data 120. It should be understood that the terms downstream data 120, 130 and upstream data 150 are optional traffic signals that typically travel via optical communications paths 127, 133, 138, such as optical fibers.

The PON 100 may be deployed for fiber-to-the-premise (FTTP), fiber-to-the-curb (FTTC), fiber-to-the-node (FTTN), and other fiber-to-the-X (FTTX) applications. The optical fiber 127 in the PON 100 may operate at bandwidths such as 155 mega bits per second (Mbps), 622 Mbps, 1.25 giga bits per second (Gbps), and 2.5 Gbps or other bandwidth implementations. The PON 100 may incorporate asynchronous transfer mode (ATM) communications, broadband services such as Ethernet access and video distribution, Ethernet point-to-multipoint topologies, and native communications of data and time division multiplex (TDM) formats or other communications suitable for a PON 100. ONTs 140, may receive and provide communications to and from the PON 100 and may be connected to standard telephones (PSTN and cellular), Internet Protocol telephones, Ethernet units, video devices, computer terminals, digital subscriber lines, wireless access, as well as any other conventional customer premise equipment.

The OLT 115 generates, or passes through, downstream communications 120 to an OSC 125. After flowing through the OSC 125, the downstream communications 120 are broadcast as power reduced downstream communications 130 to the ONUs 135a-n where each ONU 135a-n reads data 130 intended for that particular ONU 135a-n. The downstream communications 120 may also be broadcast to, for example, another OSC 155 where the downstream communications 120 are again split and broadcast to additional ONU's 160a-n and/or ONTs (not shown).

Data communications 137 may be further transmitted to and from, for example, an ONT 140 in the form of voice, video, data, and/or telemetry over copper, fiber, or other suitable connection 138 as known to those skilled in the art. The ONUs 135a-n transmit upstream communication signals 145a-n back to the OSC 125 via fiber connections 133. The OSC 125, in turn, combines the ONU 135a-n upstream signals 145a-n and transmits a combined signal 150 back to the OLT 115 which, for example, may employ a time division multiplex (TDM) protocol to determine from which ONUs 135a-n portions of the combined signal 150 are received. The OLT 115 may further transmit the communication signals 112 to a WAN 105.

Communications between the OLT 115 and the ONUs 135a-n occur using a downstream wavelength, for example 1490 nanometer (nm), and an upstream wavelength, for example 1310 nm. The downstream communications 120 from the OLT 115 to the ONUs 135a-n may be provided at 2.488 Gbps, which is shared across all ONUs. The upstream communications 145a-n from the ONUs 135a-n to the OLT 115 may be provided at 1.244 Gbps, which is shared among all ONUs 135a-n connected to the OSC 125. Other communication data rates known in the art may also be employed.

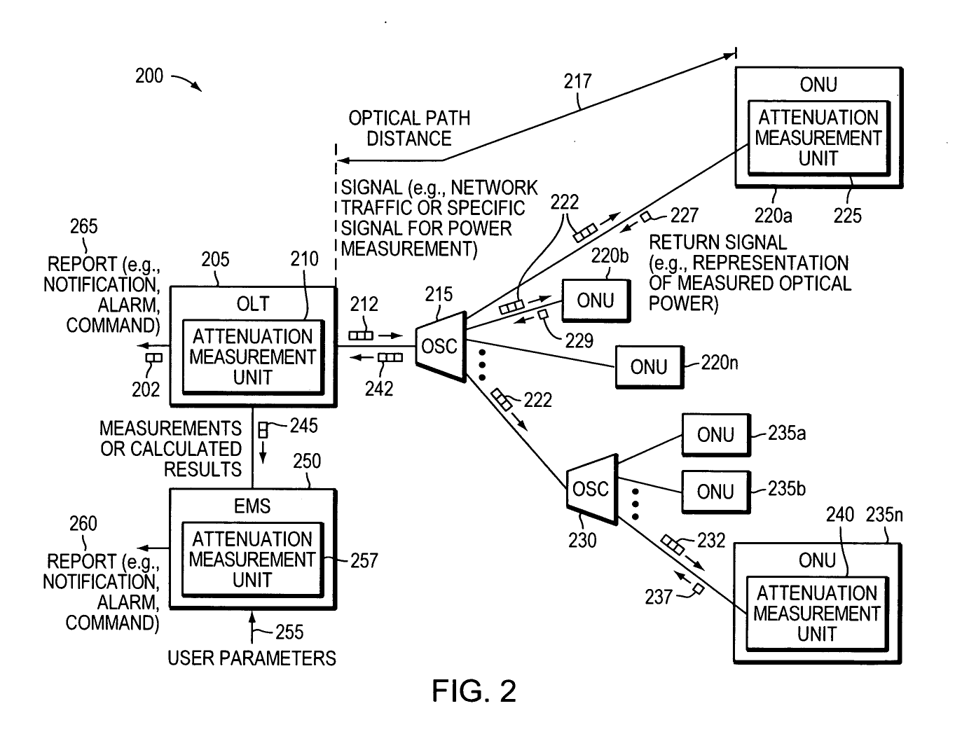

FIG. 2 is a detailed block diagram of a PON 200 employing an attenuation measurement units 210, 225, 240 in an optical network node 205, 220a-n, according to an example embodiment of the invention. Optical path attenuation as used herein, represents the optical power drop in decibels (dB) across the PON as a function of distance in kilometers (km), and may be represented in units of dB/km. Communications between an OLT 205, OSC 215, 230, and ONUs 220a-n, 235a-n may be conducted similar to that as described in FIG. 1. The OLT 205 and ONU 220a illustrate a transmitting network node and a receiving network node, respectively, according to an embodiment of the present invention.

Communication signals 202 are transmitted between the OLT 205 and a WAN (not shown). A transmitting optical network node, such as an OLT 205, transmits optical signals 212 to an OSC 215. After splitting and flowing through the OSC 215, the optical signals 222 continue to a receiving optical network node, such as the ONU 220a. The OLT 205 and/or the ONU 220a may include an attenuation measurement unit 210, 225 configured to measure the optical path attenuation.

In operation, the OLT 205 transmits an optical signal 212 to the OSC 215. The attenuation measurement unit 210 measures the optical power of the optical signal at the OLT 205. After passing through the OSC 215, the signal 222 continues to flow to the ONUs 220a-n. Optionally, the signal 222 may also flow to another OSC 230 to be further split and the signal 232 is propagated to additional ONUs 235a-n. The ONUs 220a-n, 235a-n may contain an attenuation measurement unit 225, 240 or a receive power measurement unit (not shown) that measures the received optical power of the same optical signal 222, 232. The received optical power measurement may then be transmitted (e.g., reported via a management channel) via an upstream signal 227, 229, 237. The upstream signals 227, 229, 237 are combined at the OSC 215, 230 and the combined signal 242 is then transmitted back to the OLT 205 via signal 242.

The attenuation measurement unit 210 in the OLT 205 may also include intelligence to calculate an optical path attenuation measurement as a function of the optical path distance 217. Alternatively, another device or processor (not shown) in the OLT 205 or ONU 220a-n may receive power measurements from both attenuation measurement units 210, 225 to calculate the optical path attenuation measurement as a function of the optical path distance 217.

The measured or calculated results 245 may then be communicated to an element management system 250. The EMS 250 may accept user parameters 255 for use by the attenuation measurement unit 210, 225, 240 for use in calculating the attenuation measurement. A report, such as a notification, alarm, or command 260, 265 may then be reported back to, for example, a system operator. Alternatively, an attenuation measurement unit 257 may reside in the EMS 250 or server (not shown) to perform some or all of the technique describe above.

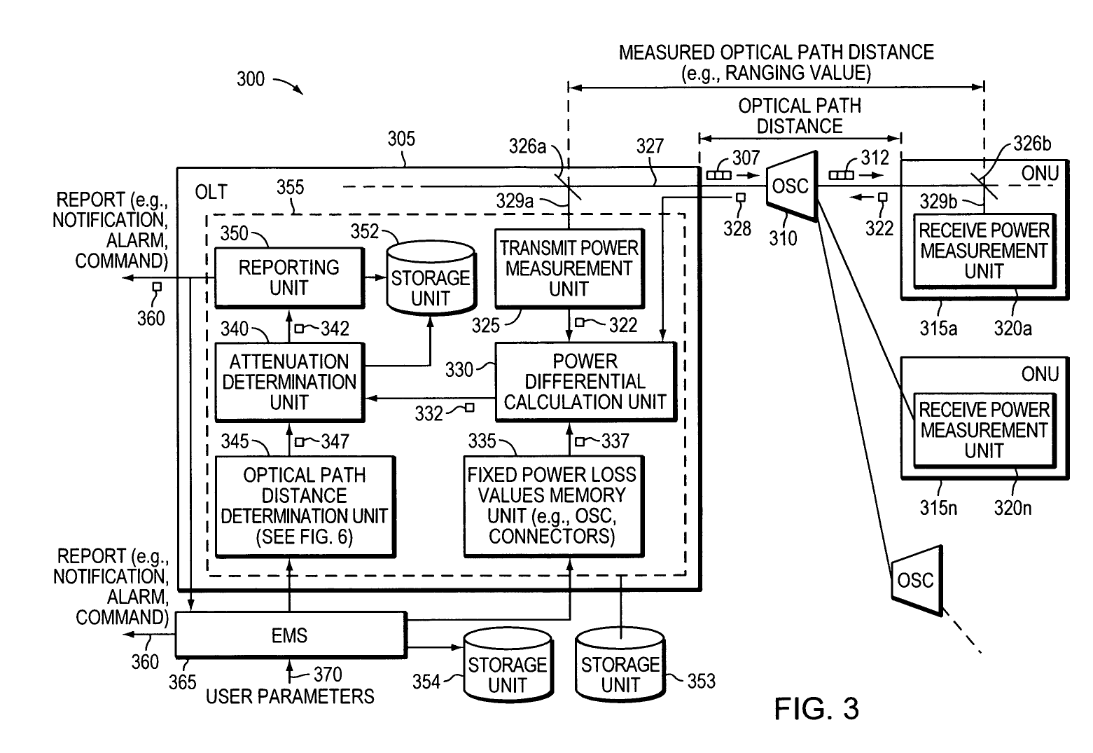

FIG. 3 is a detailed block diagram of a PON 300 further illustrating an OLT 305 that includes an attenuation measurement unit 355 and ONUs 315a-n that include receive power measurement units 320a-n according to an example embodiment of the invention. In this embodiment, optical path attenuation of a downstream optical signal 307, 312, flowing from the OLT 305 to the ONU 315a, is measured using the attenuation measurement unit 355.

In this example embodiment, the attenuation measurement unit 355 includes a transmit power measurement unit 325, power differential calculation unit 330, fixed power loss values memory unit 335, attenuation determination unit 340, optical path distance determination unit 345, and reporting unit 350. The attenuation measurement unit 355 may also include a storage unit 352, 353.

An optical signal 307 flows downstream through an OSC 310 to a plurality of ONUs 315a-n via an optical path 327. The transmit power of the optical signal 307 is measured using the transmit power measurement unit 325 by, in this example embodiment, employing a beam splitter 326a to direct a small percentage of the optical signal 307 to the transmit power measurement unit 325 via an optical path 329a. The transmit power measurement result 322 is communicated to the power differential calculation unit 330. The optical signal 307, 312 flows through the optical distribution network to the ONUs 315a-n. The receive power of the same optical signal 312 may be measured by at least one of the plurality of ONUs 315a-n by a receive power measurement unit 320a-n, again by employing a beam splitter 326b and optical path 329b. In some embodiments, during upstream communications, the receive power measurement is communicated, for example, through a management channel, via the OSC 310 back to the OLT 305. The receive optical power measurement 328 is then communicated via an upstream communications signal 322 to the power differential calculation unit 330, where the difference between the transmitted optical signal power 322 and the receive optical signal power 328 is calculated.

Optionally, a user may provide a number of parameters 370 including fixed power loss values 337 via, for example, an element management system 365, which may be stored in a fixed power loss values memory unit 335 or in a storage unit 354 for later processing. Fixed power loss values 337 may include power losses experienced as an optical signal flows through the at least one OSC 310 and/or power losses associated with connectors (not shown) used within the PON 300. Fixed power loss values may also include expected fiber attenuation (discussed below in further detail). The fixed power loss values memory unit 335 may communicate the fixed power loss values 337 to the power differential calculation unit 330 where they may be subtracted from the measured power differential value to determine a calculated power differential 332 that represents the optical power drop across an optical path between transmitting and receiving optical network nodes of the PON 300.

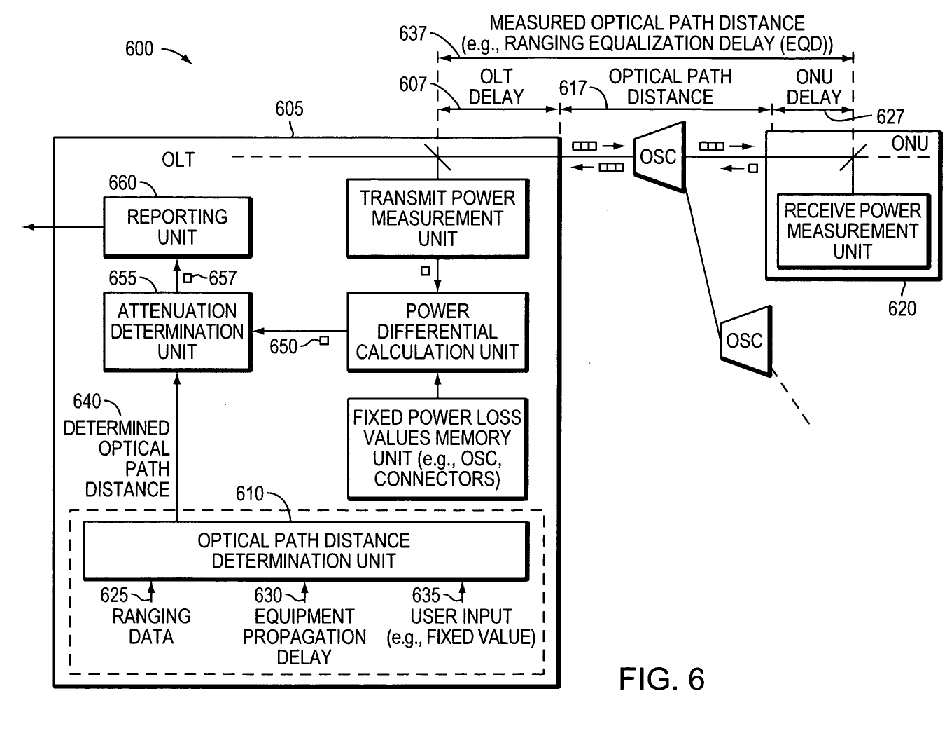

The calculated power differential value 332 is communicated to the attenuation determination unit 340. The optical path distance determination unit 345 (described below in further detail in conjunction with FIG. 6) communicates an optical path distance value 347 to the attenuation determination unit 340. The attenuation determination unit 340 calculates optical path attenuation value 342 as a function of optical path distance 347 by dividing the calculated power differential 332 by the optical path distance 347. For example, the power differential may be calculated using the following formula:

power_differential=(transmitted_power−fixed_power_losses)−received_power

The optical path attenuation may be calculated using the following formula:

$$attenuation = \frac{power\_differential}{optical\_path \_distance}$$

An attenuation measurement may be performed for each of the ONUs 320a-n since the optical path to the ONUs 320a-n may be physically different for each ONU 320a-n. The optical path attenuation result 342 may be communicated to a reporting unit 350. The reporting unit 350 may report, for example, a notification, alarm, or command 360 to, for example, a system operator (not shown). In addition, or alternatively, the report 360 may be communicated to, for example, a WAN (not shown) using the communications signals 112 as described above in FIG. 1.

In an alternative embodiment, ‘excess power loss’ may be determined. Excess power loss represents the power loss across the PON 300 where the power differential (as discussed above) is further adjusted to account for ‘expected fiber attenuation’ . Expected fiber attenuation is a parameter that is typically provided by a fiber manufacturer and represents the power loss of an optical signal, per kilometer, as it propagates through the fiber, and is expressed in dB/km. The excess power loss may be calculated using the following formula:

excess_power_loss=power_differential−(expected_fiber_attenuation*distance)

In this alternative embodiment, the expected fiber attenuation value may be provided by a user and stored in, for example, the fixed power loss values memory unit 335. The expected fiber attenuation value and/or other fixed power losses 337 may then be communicated to the power differential calculation unit 330 where the power differential is calculated. The calculated power differential and the expected fiber attenuation values 332 may then be communicated to the attenuation determination unit 340. The expected fiber attenuation value is then multiplied by the optical path distance 347 which converts the value to dB and the resulting value is then subtracted from the power differential to determine the excess power loss. The excess power loss value 342 may then be communicated to a reporting unit 350. As described above, the reporting unit 350 may report a notification, alarm, or command 360 to, for example, a system operator. Alternatively, or in addition, a report or alert may be generated when the excess power loss crosses a threshold value.

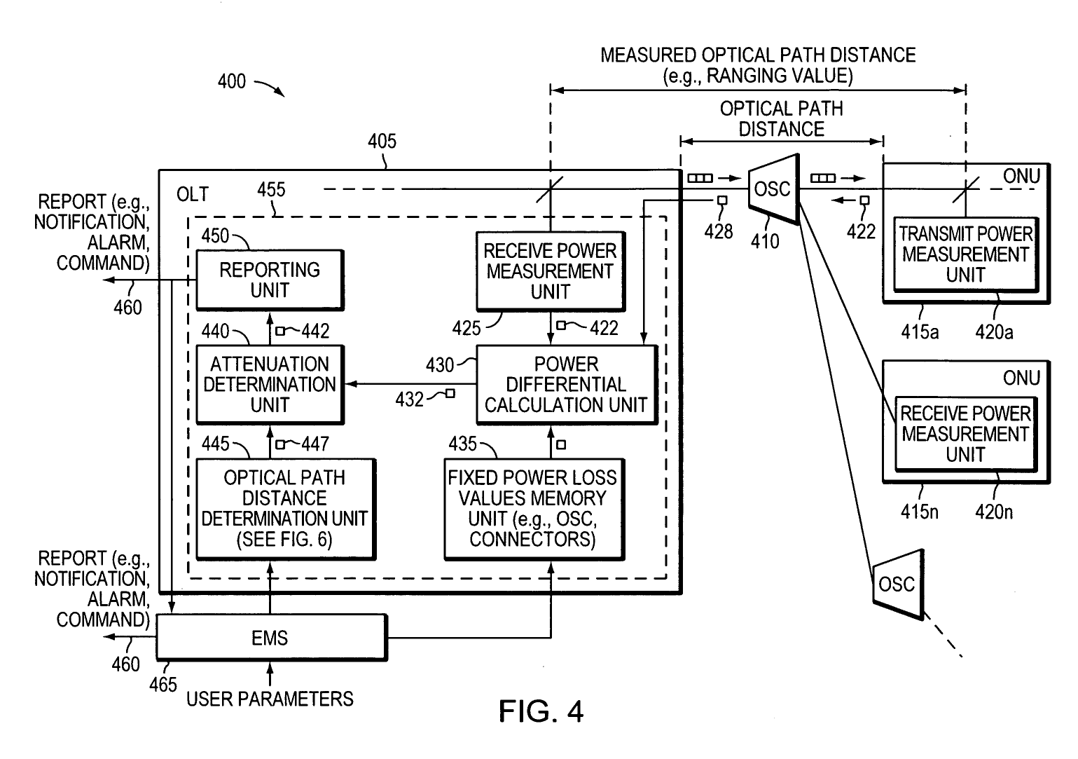

FIG. 4 is a detailed block diagram of a PON 400 illustrating an OLT 405 that includes an attenuation measurement unit 455 and ONUs 415a-n that include a transmit power measurement units 420a-n according to an example alternative embodiment of the invention. However, in this embodiment the optical path attenuation of an optical path is measured using an upstream optical signal 422 flowing from the ONUs 415a-n back to the OLT 405.

In this example embodiment, the ONU 415a transmits an upstream optical signal 422 that flows to an OSC 410 and may be combined with other upstream optical signals from other ONUs 415n. The transmit power of the optical signal 422 is measured using the appropriate transmit power measurement units 420a-n in the appropriate ONUs 415a-n. The transmit power measurement value 428 is communicated back to the OLT 405 via an upstream management channel where the transmit power measurement value 428 is further communicated to the power differential calculation unit 430.

The receive optical power of the same optical signal 422 is measured by the receive power measurement unit 425 in the OLT 405. The received optical power measurement value 422 is communicated to the power differential calculation unit 430 where the difference between the transmitted optical signal power 428 and the receive optical signal power 422 is calculated. Optionally, a user may provide a number of parameters including fixed power losses 435 via, for example, an element management system 465. Fixed power loss values 435 may include power losses incurred as a signal flows through the at least one OSC 410 and/or power losses associated with connectors (not shown) used within the PON 400. These fixed power loss values 435 may be subtracted from the measured power differential value to determine a calculated power differential 432 which represents the optical power drop across the PON 400.

The calculated power differential 432 is communicated to the attenuation determination unit 440. An optical path distance 447 is also communicated to the attenuation determination unit 440 via an optical path distance determination unit 445, which will be described below in further detail in conjunction with FIG. 6. The attenuation determination unit 440 calculates optical path attenuation as a function of optical path distance 447 by dividing the calculated power differential 432 by the optical path distance 447 using the formula described above.

The optical power attenuation result 442 may be communicated to a reporting unit 450. The reporting unit 450 may report, for example, a notification, an alarm, or a command 460, to, for example, a system operator (not shown). In addition, or alternatively, the report 460 may be communicated to, for example, a WAN (not shown) using the communications signals 110 as described above in FIG. 1.

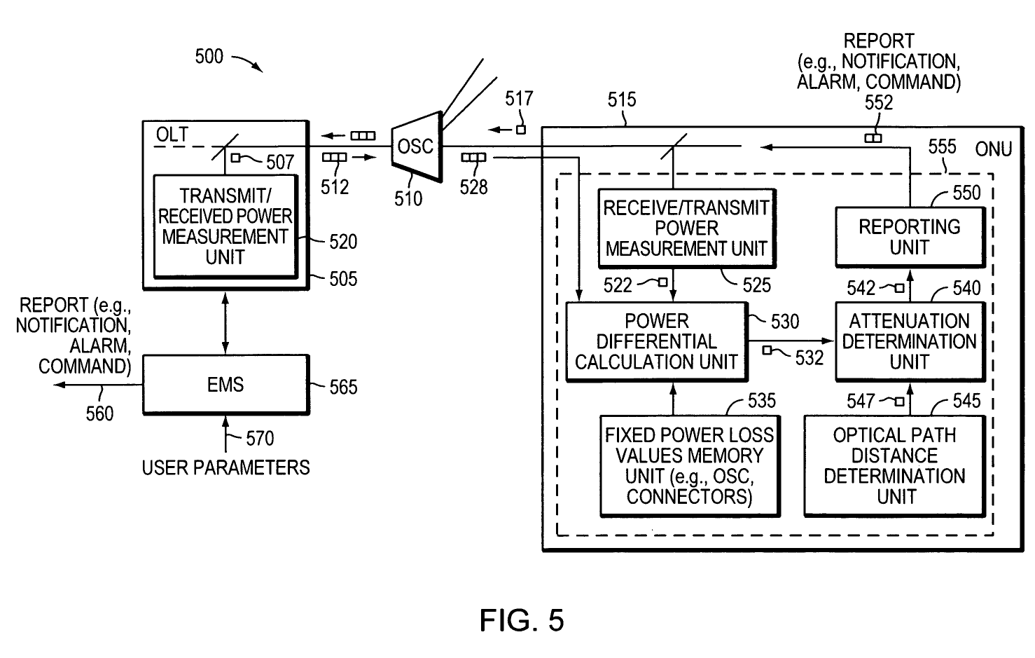

FIG. 5 is a detailed block diagram of a PON 500 employing an alternative example embodiment of the invention. In this example embodiment, the power differential between a transmitted optical signal and a receive optical signal of a downstream optical communication signal 512 is calculated.

An OLT 505 transmits a downstream signal 512 to at least one ONU 515 via at least one OSC 510. The ONU 515 may contain an attenuation determination unit 555 such as the attenuation determination unit 455 described above in conjunction with FIG. 4. The transmit power 507 of the optical signal 512 is measured by a transmit/receive power measurement unit 520 in the OLT 505 and transmitted to the power differential calculation unit 530 in the ONU 515 via a downstream communications signal 528. A receive power 522 of the same optical signal 528 is measured at the ONU 515 by a receive/transmit power measurement unit 525 and further communicated to the power differential calculation unit 530.

The power differential calculation unit 530 then calculates the difference between the transmit optical power 507 and the receive optical power 522 of the same optical signal 512. Optionally, a user may provide a number of user parameters 570 including fixed power loss values 535 via, for example, an element management system 565 that may be communicated to the attenuation determination unit 555 via a network traffic communications signal such as the optical signal 512. Fixed power loss values 535 may include power losses incurred as a signal flows through the at least one OSC 510 and/or power losses associated with connectors (not shown) used within the PON 500. The fixed power losses 535 may be used to calculate the calculated power differential value 532 which represents the optical power drop across the PON 500.

The calculated power differential value 532 is communicated to the attenuation determination unit 540. The optical path distance 547 is also communicated to the attenuation determination unit 540 via an optical path distance determination unit 545. An attenuation measurement value 542 is determined using a calculation such as that described above in conjunction with FIG. 2. The attenuation measurement value 542 may be communicated to the reporting unit 550. The reporting unit 550 may then communicate a report, or measurements, or calculated results 552, or any combination thereof, to, for example, an EMS 565, a service provider (not shown), or the transmitting optical node, such as the OLT 505 via an upstream communications signal 517.

Continuing to refer to FIG. 5, in still another alternative example embodiment of the invention, the optical path attenuation between the OLT 505 and the ONU 515 may be measured using an upstream optical signal 517. In this embodiment, the transmitted and received power differential of the upstream optical signal 517 is calculated.

The ONU 515 transmits an upstream signal 517 to an OLT 505 via at least one OSC 510. The transmit power of the upstream optical signal 517 is measured by a receive/transmit power measurement unit 525 located in the ONU 515 and the result 522 is communicated to the power differential calculation unit 530. The receive power measurement 507 of the same upstream optical signal 517 is measured at the OLT 505 by a transmit/receive power measurement unit 520. The received optical power measurement 507 is communicated back to the ONU 515 using a downstream communications signal 512 and then to the power differential calculation unit 530 within the attenuation determination unit 555.

The power differential calculation unit 530 then calculates the difference between the transmitted optical power 522 and the received optical power 507 of the same optical signal 517. Similarly, a user may optionally provide fixed power losses 535 representing various losses incurred in the PON 500. These losses may be communicated to the power differential calculation unit 530 for use in calculating the power differential 532.

The calculated power differential result 532 is then communicated to the attenuation determination unit 540. The determined optical path distance 547 is also communicated to the attenuation determination unit 540 via the optical path distance determination unit 545. An attenuation measurement value 542 is determined and communicated to the reporting unit 550. The reporting unit 550 may then communicate a report, or measurements, or calculated results 552, or any combination thereof, to, for example, an EMS 565, a service provider (not shown), or the OLT 505.

FIG. 6 is a detailed block diagram illustrating in further detail a PON 600 employing an example embodiment of a network node, for example, OLT 605, that includes an optical path distance determination unit 610. As discussed above, optical path attenuation is a function of distance. The optical path distance 617 represents the distance between a transmitting network node, such as an OLT 605, and a receiving network node, such as an ONU 620.

The optical path distance 617 may be determined using ranging data 625. The ranging process, such as that described in International Telecommunications Union-Telecommunication (ITU-T) G.984.3 (2004), is a technique of measuring the logical distance between each ONU and its associated OLT to determine the optical path propagation time such that upstream data sent from one ONU on the same PON does not collide with data sent from a different ONU. The measured logical optical path distance 637 is also referred to as the equalization delay (EQD) and is used interchangeably herein.

The EQD 637 returned by the ranging process is very accurate—in the order of a few upstream bit-times. For example, in a gigabit PON the upstream bit length is about 0.8 nanoseconds which translates to about 16 centimeters of light propagation. Therefore, measurement to a byte level is about 1 meter accurate in a PON 600 that may be, for example, 10 kilometers in length.

However, the EQD 637 also includes equipment propagation delays within the network nodes. The equipment propagation delay 630 may include, for example, an OLT delay 607 and an ONU delay 627. These values may also vary between different equipment vendors. These delay may be accounted for by assuming a fixed delay within the network node of, for example, 20 meters in distance or about 100 nanoseconds. Alternatively, if the equipment delays 607, 627 are larger that a few tens of meters, the distance may be calibrated by, for example, comparing the EQD 637 of a reference ONU 620 with a know fiber length measured at a known temperature.

The measured EQD 637 and the equipment propagation delay 630 are communicated to the optical path distance determination unit 610 where the EQD is converted from bits to a representation of distance in kilometers. The optical path distance 617 may be determined using the following formula:

$$optical\_path \_distance = \frac{EQD - ( OLT\_delay + ONU\_delay )}{2}$$

The delays are divided by 2 because they represents the round trip delay which includes the downstream and upstream propagation time.

Alternatively, a system operator may provide a determined optical path distance 640 as user input 635 via, for example, an element management system (not shown). This may be a fixed value such as a distance measured during deployment of the PON, a test value, a calculate value, etc.

Similar to that described above in FIG. 3, the determined optical path distance 640 and the calculated power differential 650 are communicated to the attenuation determination unit 655. The determined optical path attenuation value 657 may be communicated to the reporting unit 660 and/or an element management system (not shown).

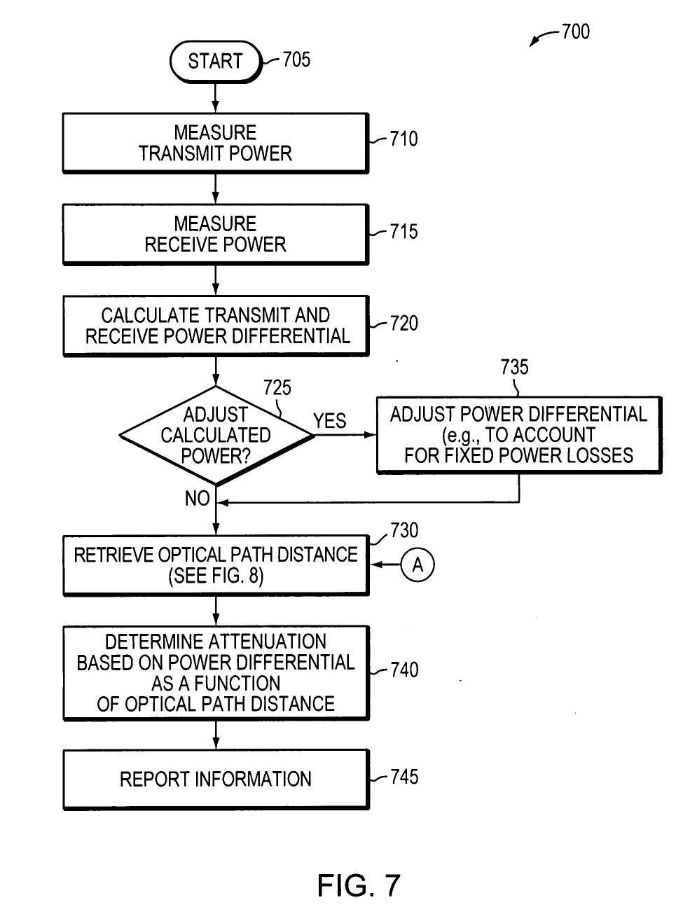

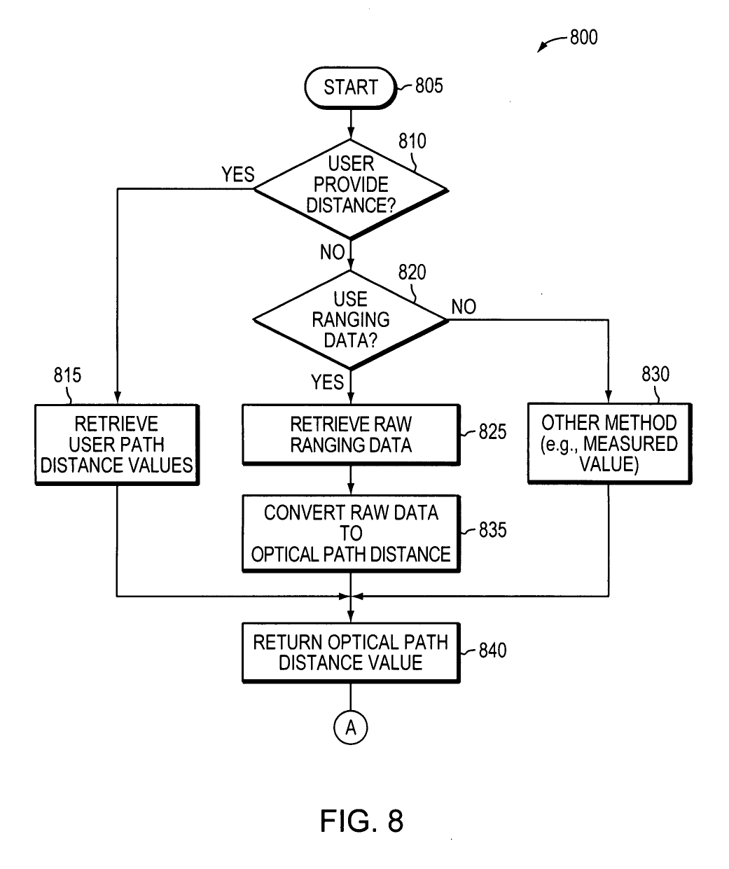

FIG. 7 is an example flow diagram of a process 700 illustrating an embodiment of the present invention. The process 700 starts (705) and a transmitting optical network node measures a transmit optical power (710) of an optical signal. A receiving optical network node measures a receive optical power (715) of the same optical signal. A calculating unit calculates a power differential (720) between the transmit and receive optical power measurements. If the calculated power is to be adjusted (725), the process 700 adjusts the power differential, for example, to account for fixed power losses (735). The process 700 retrieves a determined optical path distance (730) described below in further detain in conjunction with FIG. 8. An optical path attenuation may be determined based on the calculated power differential as a function of optical path distance (740). The determined attenuation result may be reported (745) to, for example, a system operator or element management system.

FIG. 8 is an flow diagram of a process 800 to determine an optical path distance according to an example embodiment of the invention. The process 800 starts (805) and if a user provides optical path distance information (810) the process 800 retrieves the user provided values (815). If not, the process 800 determines if ranging data is to be used (820), and if so, the process 800 retrieves raw ranging data (825) and converts it from, for example, bits to a representation of optical path distance (835). If not, the process 800 may use other methods as described above in FIG. 6. The process 800 returns the determined optical path distance value (840) to the calling process, for example, ‘A’ as shown in FIG. 7.

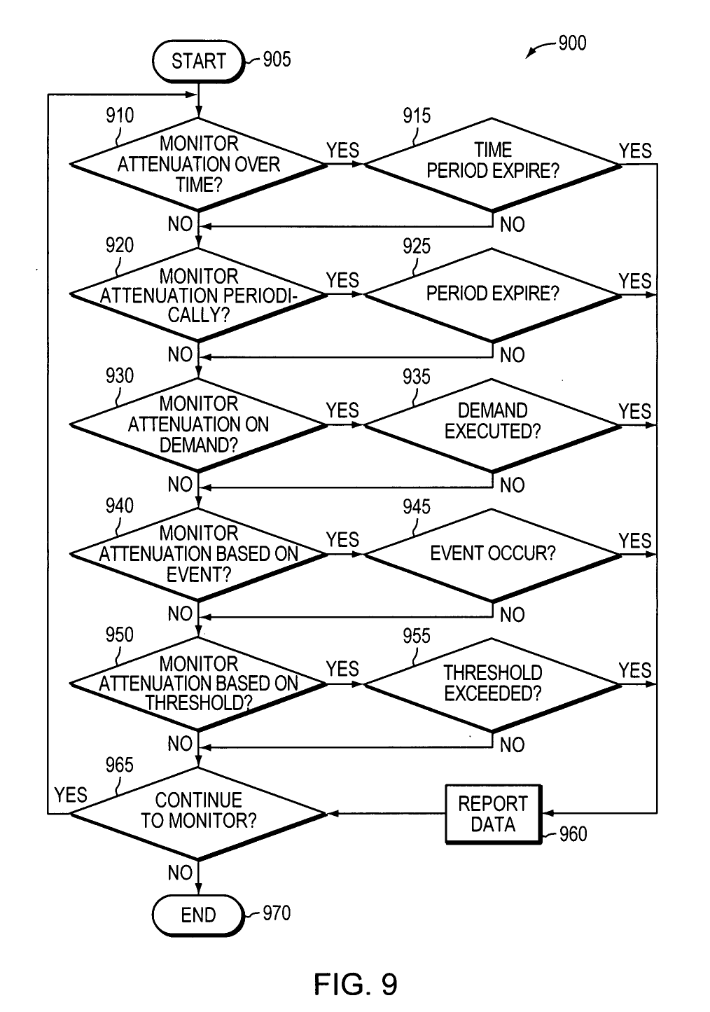

FIG. 9 is an example flow diagram illustrating a process 900 to report data indicative of an optical path attenuation according to an example embodiment of the invention. One, or a combination thereof, of monitoring methods may be used to report data. The process 900 starts (905) and determines whether to monitor attenuation over a particular time period (910) and if so, whether the time period has expired (915). If the time period has expired (915), the process 900 reports the data (960). Monitoring attenuation over time may allow a system operator to detect and/or predict optical path degradation that occurs over short and long time periods, allowing the system operator to, for example, proactively maintain a PON, thereby reducing or preventing communications errors and service outages.

Next, the process 900 determines whether to monitor attenuation periodically (920) and if so, whether the period has expired (925). If the period has expired (925), the process 900 reports the data (960). The process 900 then determines whether to monitor attenuation on-demand (930) and if so, whether the demand was executed (935). If the demand has executed (935), the process 900 reports the data (960). The process 900 continues and determines whether to monitor attenuation on an event-driven basis (940) and if so, whether the event has occurred (945). If the event has occurred (945), the process 900 reports the data (960). The process 900 continues further and determines whether to monitor attenuation based on a threshold preconfigured by, for example, a service provider (950) and if so, whether the data exceeds the threshold (955). If the data exceeds the threshold (955), the process 900 reports the data (960). The process 900 then determines whether to continue to monitor the attenuation data, and if so, continue with step 910 to repeat the process. If not, the process 900 ends (970).

It should be readily appreciated by those of ordinary skill in the art that the aforementioned steps are merely exemplary and that the present invention is in no way limited to the number of steps or the ordering of steps described above.

While this invention has been particularly shown and described with references to example embodiments thereof, it will be understood by those skilled in the art that various changes in form and details may be made therein without departing from the scope of the invention encompassed by the appended claims.

What is claimed is:

1. A method of determining attenuation of an optical path between two optical network nodes, the method comprising:
calculating a power differential between a transmitted optical power of an optical signal and a received optical power of the same optical signal, the transmitted optical power measured at a transmitting optical network node and the received optical power measured at a receiving optical network node in communication with the transmitting network node via an optical path;
determining optical path attenuation based on the calculated power differential as a function of an optical path distance between the transmitting and receiving optical network nodes; and
reporting information indicative of the optical path attenuation.

2. The method according to claim 1 wherein calculating the power differential includes adjusting the calculated power differential to account for fixed power losses between the transmitting and receiving optical network nodes.

3. The method according to claim 2 further including accepting parameters from a user related to the fixed power losses.

4. The method according to claim 1 wherein the optical signal is a traffic signal carrying network communications.

5. The method according to claim 1 further including calculating the optical path distance between the transmitting and receiving optical network nodes based on ranging parameters.

6. The method according to claim 5 wherein calculating the optical path distance includes removing propagation delays of the transmitting and receiving optical network nodes from the optical path distance.

7. The method according to claim 1 further including accepting parameters from a user related to the optical path distance.

8. The method according to claim 1 further including forwarding a representation of the received optical power measurement from the receiving optical network node to the transmitting optical network node.

9. The method according to claim 1 further including forwarding measurements, or calculated results, or both, from the transmitting optical network node to at least one of the following: a management node, a server, a service provider, or the receiving optical network node.

10. The method according to claim 1 further including forwarding a representation of the transmitted optical power measurement from the transmitting optical network node to the receiving optical network node.

11. The method according to claim 1 further including forwarding measurements, or calculated results, or both from the receiving optical network node to at least one of the following: a management node, a server, a service provider, or the transmitting optical network node.

12. The method according to claim 1 further including monitoring for a change in attenuation of the optical path over time.

13. The method according to claim 1 further including determining the attenuation of the optical path periodically, on an on-demand basis, or on an event driven basis.

14. The method according to claim 1 wherein reporting information indicative of the optical path attenuation includes alerting a service provider if a change in attenuation exceeds a threshold.

15. The method according to claim 1 wherein reporting information indicative of the optical path attenuation is selected from at least one of the following:
issuing an alarm, causing the transmitting or receiving optical network node to change states, issuing a command, issuing a notification, issuing a threshold crossing alert, or a measured result.

16. The method according to claim 1 wherein the transmitting optical network node is an Optical Line Terminal (OLT) and the receiving optical network node is an Optical Network Unit (ONU) downstream of the OLT.

17. The method according to claim 1 wherein the transmitting optical network node is an Optical Network Unit (ONU) and the receiving optical network node is an Optical Line Terminal (OLT) upstream of the ONU.

18. An apparatus to determine attenuation of an optical path between two optical network nodes, the apparatus comprising:
a calculation unit to calculate a power differential between a transmitted optical power of an optical signal and a received optical power of the same optical signal, a transmit power measurement unit to measure optical power of the optical signal at a transmit optical network node, and a receive measurement unit to measure optical power at a receive optical network node in communication with the transmit network node via an optical path;
a determination unit to determine attenuation of the optical path based on the calculated power differential as a function of an optical path distance between the transmitting and receiving optical network nodes; and
a reporting unit to report information indicative of the optical path attenuation.

19. The apparatus according to claim 18 wherein the calculation unit is configured to adjust the power differential to account for fixed power losses between the transmit and receive optical network nodes.

20. The apparatus according to claim 19 wherein the calculation unit is configured to accept parameters from a user related to the fixed power losses.

21. The apparatus according to claim 18 wherein the optical signal is a traffic signal that carries network communications.

22. The apparatus according to claim 18 wherein the calculation unit is configured to calculate the optical path distance between the transmit and receive optical network nodes based on ranging parameters.

23. The apparatus according to claim 21 wherein the optical path distance determination unit is configured to determine an optical path distance which removes fixed delays at the transmit and receive optical network nodes from the calculated optical path distance.

24. The apparatus according to claim 18 wherein the optical path distance determination unit is configured to accept parameters from a user related to the optical path distance.

25. The apparatus according to claim 18 wherein the receive optical network node is configured to forward a representation of the receive optical power measurement to the transmit optical network node.

26. The apparatus according to claim 18 wherein the transmit optical network node is configured to forward measurements, or calculated results, or both, to at least one of the following: a management node, a server, a service provider, or the receive optical network node.

27. The apparatus according to claim 18 wherein the transmit optical network node is configured to forward a representation of the transmit optical power measurement to the receive optical network node.

28. The apparatus according to claim 18 wherein the receive optical network node is configured to forward measurements, or calculated results, or both, from the receive optical network node to at least one of the following: a management node, a server, a service provider, or the transmit optical network node.

29. The apparatus according to claim 18 the apparatus is configured to monitor for a change in attenuation of the optical path over time.

30. The apparatus according to claim 18 wherein the apparatus is configured to determine the attenuation of the optical path periodically, on an on-demand basis, or on an event driven basis.

31. The apparatus according to claim 18 wherein the reporting unit is configured to alert a service provider if a change in attenuation exceeds a threshold preconfigured by a service provider.

32. The apparatus according to claim 18 wherein the transmit optical network node is an Optical Line Terminal (OLT) and the receive optical network node is an Optical Network Unit (ONU) downstream of the OLT.

33. The apparatus according to claim 18 wherein the transmit optical network node is an Optical Network Unit (ONU) and the receive optical network node is an Optical Line Terminal (OLT) upstream of the ONU.

34. A method of determining attenuation of an optical path between two optical network nodes, the method comprising:
calculating a power differential between a transmitted optical power of an optical signal and a received optical power of the same optical signal, the transmitted optical power preconfigured by a user and the received optical power measured at a receiving optical network node in communication with the transmitting network node via an optical path;
determining optical path attenuation based on the calculated power differential as a function of an optical path distance between the transmitting and receiving optical network nodes; and
reporting information indicative of the optical path attenuation.
